(19) United States
(12) Patent Application Publication
(10) Pub. No.: US 2017/0186525 A1
(43) Pub. Date: Jun. 29, 2017

(54) INDUCTOR, MAGNETIC MATERIAL COMPOSITION USED FOR THE SAME, AND MANUFACTURING METHOD OF ELECTRONIC COMPONENT

(71) Applicants: DARFON ELECTRONICS (SUZHOU) CO., LTD., Jiangsu Province (CN); Darfon Electronics Corp., Taoyuan City (TW)

(72) Inventors: Yung-Ping Wu, Tainan City (TW); Ran-Rong Lee, Hsinchu County (TW); Chi-Ming Huang, Taoyuan City (TW); Chao-Kuang Hsiao, Tainan City (TW); Bai-Yang Wang, Tainan City (TW)

(73) Assignees: DARFON ELECTRONICS (SUZHOU) CO., LTD., Jiangsu Province (CN); Darfon Electronics Corp., Taoyuan City (TW)

(21) Appl. No.: 15/206,299

(22) Filed: Jul. 10, 2016

(30) Foreign Application Priority Data
Dec. 25, 2015 (TW) 104143885

(51) Int. Cl. H01F 27/255; H01F 27/28; H01F 41/12; H01F 41/02; H01F 41/064; H01F 1/03; H01F 27/32

(52) U.S. Cl. CPC H01F 27/255; H01F 1/0306; H01F 27/2823; H01F 27/32; H01F 41/0246; H01F 41/064; H01F 41/125

(57) ABSTRACT

An inductor, a magnetic material composition used for the inductor, and a manufacturing method of an electronic component. The magnetic material composition used for the inductor includes 100 weight parts of a magnetic metal powder and 0.05-1 weight part of an inorganic ceramic powder. The magnetic metal powder includes 94.5 wt % or higher of iron, and the inorganic ceramic powder includes aluminum oxide.

This application claims the benefit of Taiwan application Serial No. 104143885, filed Dec. 25, 2015, the subject matter of which is incorporated herein by reference.

### BACKGROUND

Technical Field

The present disclosure relates to an inductor, a magnetic material composition used for inductors, and a manufacturing method of an electronic component, and particularly to an inductor having high hardness and anti-corrosive characteristics, a magnetic material composition used for inductors, and a manufacturing method of an electronic component.

Description of the Related Art

Due to the current trend of size reductions of mobile devices, the storage electric quantities of batteries are reduced accordingly along with the size reductions of devices. Due to the charging requirements of mobile devices, transformers and the inductor elements thereof are generally installed in various electronic products.

Generally speaking, inductor elements are made usually by winding conducting wires around a magnetic body following covering and protecting the conducting wires by an exterior resin. The composition of the magnetic body basically includes iron and silicon, and chromium of such as equal to or higher than 10 wt % can be further added into the composition of the magnetic body. Chromium can form an insulating oxide layer on the surfaces of particles in the magnetic body, which is helpful to the performance of the overall electrical properties of the inductor elements, and the insulating oxide layer is such as an iron chromium oxide layer formed from such as chromium together with iron. However, the composition of the magnetic body including chromium forms a porous structure, such that the exterior resin penetrates through the surface of the magnetic body and leaks into the magnetic body with a leakage depth of even up to 30 μm. The leakage causes undesirable influences on the hardness of the magnetic body and may further influence the reliability and characteristics of the inductor element.

Therefore, how to provide an inductor element with excellent reliability and electromagnetic characteristics has become a prominent task for the industries.

### SUMMARY

The present disclosure relates in general to an inductor, a magnetic material composition used for inductors, and a manufacturing method of an electronic component.

According to an embodiment of the present disclosure, a magnetic material composition used for an inductor is provided. The magnetic material composition includes 100 weight parts of a magnetic metal powder and 0.05-1 weight part of an inorganic ceramic powder. The magnetic metal power includes 94.5 wt % or higher of iron, and the inorganic ceramic powder includes aluminum oxide.

According to another embodiment of the present disclosure, an inductor is provided. The inductor includes a magnetic material body, a conducting wire, and an exterior resin part. A composition of the magnetic material body includes 100 weight parts of a magnetic metal powder and 0.05-1 weight part of an inorganic ceramic powder, the magnetic metal power includes 94.5 wt % or higher of iron, and the inorganic ceramic powder includes aluminum oxide. The conducting wire winds around the magnetic material body. The exterior resin part covers the conducting wire.

According to a further embodiment of the present disclosure, a manufacturing method of an electronic component is provided. The manufacturing method of the electronic component includes the following steps: providing a magnetic material composition, the magnetic material composition including: 100 weight parts of a magnetic metal powder, the magnetic metal power including 94.5 wt % or higher of iron; and 0.05-1 weight part of an inorganic ceramic powder, the inorganic ceramic powder including aluminum oxide; sintering the magnetic material composition for manufacturing a magnetic material body, the magnetic material body including a magnetic core mainly made of the magnetic metal powder and an inorganic ceramic surface layer mainly made of the inorganic ceramic powder, the inorganic ceramic surface layer having a ceramic external surface; winding a cladding conducting wire around the magnetic material body; and coating a resin material on a peripheral of the cladding conducting wire for forming an exterior resin part, wherein the exterior resin part covering the peripheral of the cladding conducting wire and contacting a portion of a surface of the magnetic material body is blocked by the inorganic ceramic surface layer, the ceramic external surface forms an interface between the exterior resin part and the magnetic material body, and the inorganic ceramic surface layer is formed between the exterior resin part and the magnetic core for separating the exterior resin part from contacting the magnetic core.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows a top view of an inductor according to an embodiment of the present disclosure; and

FIG. 2 shows a cross-sectional view along the section line 2-2′ in FIG. 1.

### DETAILED DESCRIPTION

According to the embodiments of the present disclosure, in the composition of the magnetic material body of the inductor, the inorganic ceramic surface layer formed of the inorganic ceramic powder can effectively protect the magnetic core to achieve anti-corrosion effects, and the overall hardness of the magnetic material body can be further increased to achieve the effects of preventing the resin material of the exterior resin part from leaking into the magnetic material body. A number of embodiments of the present disclosure are described below with accompanying drawings. The elements in the drawings sharing the same or similar labels are the same or similar elements. The elements in the drawings sharing the same or similar labels are the same or similar elements. It should be noted that the accompanying drawings are simplified for more clearly elaborating the embodiments of the present disclosure, and detailed structures disclosed in the embodiments are for description not for limiting the scope of protection of the present disclosure. Also, anyone who is skilled in the technology field of the present disclosure can make necessary modifications or variations to these structures according to the needs in actual implementations.

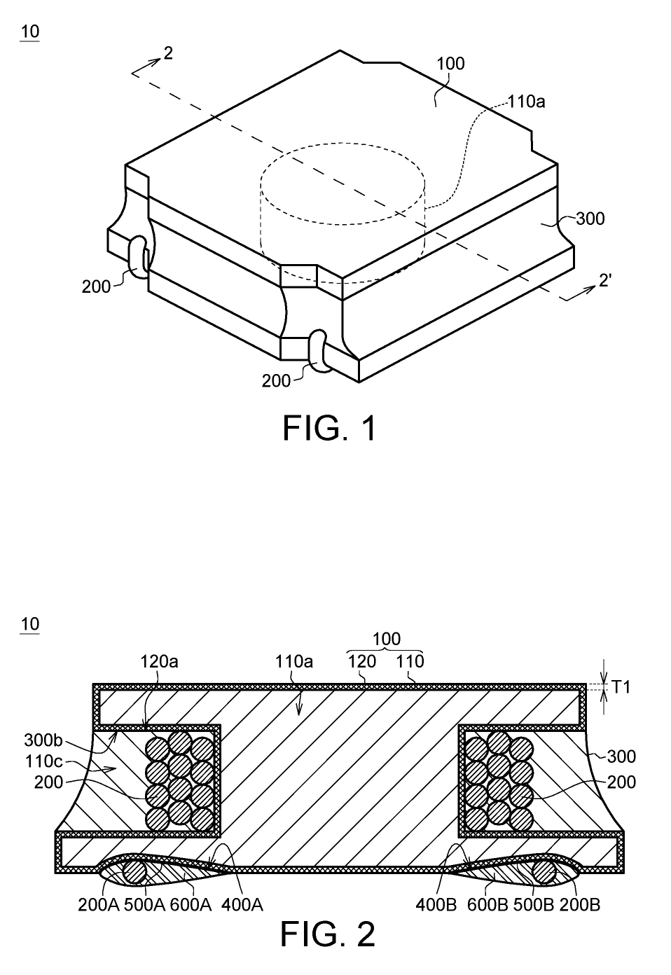

FIG. 1 shows a top view of an inductor according to an embodiment of the present disclosure, and FIG. 2 shows a cross-sectional view along the section line 2-2′ in FIG. 1. As shown in FIGS. 1-2, the inductor 10 includes a magnetic material body 100, a conducting wire 200, and an exterior resin part 300. A composition of the magnetic material body 100 includes 100 weight parts of a magnetic metal powder and 0.05-1 weight part of an inorganic ceramic powder, the magnetic metal power includes 94.5 wt % or higher of iron, and the inorganic ceramic powder includes aluminum oxide. The conducting wire 200 winds around the magnetic material body 100. The exterior resin part 300 covers the conducting wire 200.

As shown in FIG. 2, the magnetic material body 100 includes a magnetic core 110 and an inorganic ceramic surface layer 120, and the inorganic ceramic surface layer 120 has a ceramic external surface 120a. In one embodiment, the inorganic ceramic surface layer 120 may cover, for example, the whole external surface of the magnetic core 110 for completely separating the magnetic core 110 from the exterior resin part 300.

According to the embodiments, the inorganic ceramic surface layer 120 formed of 0.05-1 weight part of the inorganic ceramic powder can effectively protect the magnetic core 110 to achieve anti-corrosion effects and prevent the magnetic core 110 from being damaged by the following electroplating process; moreover, the inorganic ceramic surface layer 120 can further increase the overall hardness of the magnetic material body to achieve the effects of preventing the resin material of the exterior resin part 300 from leaking into the magnetic material body 100.

According to the embodiments of the present disclosure, while the content of the inorganic ceramic powder is higher than 1 weight part, the inorganic ceramic material may form aggregation on the surface of the magnetic core 110 in the manufacturing process, causing the decreases of surface resistance and inductance and having undesirable influences on the electromagnetic characteristics of the inductor 10. While the content of the inorganic ceramic powder is lower than 0.05 weight part, the inorganic ceramic surface layer 120 having sufficient covering abilities cannot be formed.

In some embodiment, the magnetic metal powder is formed mainly by such as iron. In some other embodiments, the magnetic metal powder may further include 3-5.5 wt % of silicon; for example, the magnetic metal powder is formed from such as iron and silicon.

In the embodiment, the inorganic ceramic powder may include 10-20 wt % of boron oxide (B₂O₃). For example, in one embodiment, the inorganic ceramic powder includes such as borosilicate glass including 10-20 wt % of boron oxide.

In the embodiment, the inorganic ceramic powder may include 10-20 wt % of phosphorus oxide (P₂O₅). For example, in one embodiment, the inorganic ceramic powder includes such as phosphosilicate glass including 10-20 wt % of phosphorus oxide.

Conventionally, chromium is added into the compositions of magnetic bodies of inductors for achieving anti-corrosion functions. According to the embodiments of the present disclosure, the composition of the magnetic material body 100 does not include chromium; in contrast, the composition of the magnetic material body 100 includes 0.05-1 weight part of the inorganic ceramic powder, thereby the hardness of the magnetic material body 10 can be greatly increased, and the effects of anti-corrosion and preventing the resin material of the exterior resin part 300 from penetrating into the magnetic material body 100 can be further achieved.

In the embodiment, the inorganic ceramic powder may include zinc oxide (ZnₓO).

In the embodiment, an average particle diameter of the inorganic ceramic power is such as 2-12 μm.

In the embodiment, an average particle diameter of the magnetic metal powder is such as larger than or equal to an average particle diameter of the inorganic ceramic powder. For example, in one embodiment, the average particle diameter of the magnetic metal powder is such as 2-5 times of the average particle diameter of the inorganic ceramic powder. As such, the inorganic ceramic powder(s) can be filled within the slits between the stacked magnetic metal powders; consequently, a better insulation between magnetic metal powders can be further provided, and the stacked density of the magnetic metal powders is not deceases due to the addition of the inorganic ceramic powder(s); hence, the predetermined inductance value can be maintained, and the structural strength of the magnetic core 110 can be increased.

As shown in FIG. 2, the magnetic core 110 has an annular recess 110c and a central pillar 110a, the conducting wire 120 is disposed in the annular recess 110c and winding around the central pillar 110a, and the inorganic ceramic surface layer 120 covers at least an inner surface of the annular recess 110c and a side surface of the central pillar 110a.

In the embodiment, the inorganic ceramic surface layer 120 has a thickness T1 of such as 15-60 μm.

In the embodiment, as shown in FIG. 2, the exterior resin part 300 has a resin surface 300b blocked by the inorganic ceramic surface layer 120. The ceramic external surface 120a of the inorganic ceramic surface layer 120 forms an interface between the exterior resin part 300 and the magnetic material body 100, and the inorganic ceramic surface layer 120 is formed between the exterior resin part 300 and the magnetic core 110 for separating the exterior resin part 300 from contacting the magnetic core 110.

In the embodiment, as shown in FIG. 2, the inductor 10 may further include terminal electrodes 500A and 500B, and the terminal electrodes 500A and 500B are respectively disposed in the recesses 400A and 400B and connected respectively to the terminals 200A and 200B of the conducting wire 200. The terminals 200A and 200B of the conducting wire 200 are electrically connected to the terminal electrodes 500A and 500B respectively via the solders 600A and 600B respectively.

According to the embodiments of the present disclosure, a manufacturing method of an electronic component is provided hereinafter.

Please refer to FIGS. 1-2. First, a magnetic material composition is provided, and the magnetic material composition includes 100 weight parts of a magnetic metal powder and 0.05-1 weight part of an inorganic ceramic powder. The magnetic metal power includes 94.5 wt % or higher of iron, and the inorganic ceramic powder includes aluminum oxide.

Next, the magnetic material composition is sintered for manufacturing a magnetic material body 100 as aforementioned. The magnetic material body 100 includes a magnetic core 110 mainly made of the aforementioned magnetic metal powder and an inorganic ceramic surface layer 120 mainly made of the aforementioned inorganic ceramic powder, and the inorganic ceramic surface layer 120 has a ceramic external surface 120a. In the embodiment, the sintering temperature is such as higher than the glass transition temperature (Tg) of the inorganic ceramic powder. In one embodiment, the sintering temperature is such as 700-900° C.

Specifically speaking, after the thermal treatment, due to the sintering temperature of the thermal treatment is higher than the glass transition temperature of the inorganic ceramic powder (ceramic material), the inorganic ceramic powder would turn into liquid phase and flows to the surface region of the magnetic material body 100 forming the inorganic ceramic surface layer 120 on the surface of the magnetic core 110. The inorganic ceramic surface layer 120 can effectively protect the magnetic core 110 to achieve anti-corrosion effects.

Next, a cladding conducting wire is winding around the magnetic material body 100, and the cladding conductive wire is such as the conducting wire 200 aforementioned.

Next, a resin material is coated on a peripheral of the cladding conducting wire for forming an exterior resin part 300 aforementioned. The resin material may include such as a magnetic material. The exterior resin part 300 covers the peripheral of the cladding conducting wire and contacting a portion of the surface of the magnetic material body 100 is blocked by the inorganic ceramic surface layer 120. The ceramic external surface 120a forms an interface between the exterior resin part 300 and the magnetic material body 100, and the inorganic ceramic surface layer 120 is formed between the exterior resin part 300 and the magnetic core 110 for separating the exterior resin part 300 from contacting the magnetic core 110. As such, an electronic component is manufactured, and the electronic component is such as the inductor 10 aforementioned.

Further explanation is provided with the following examples. Magnetic material compositions of the magnetic material bodies and the test results of the characteristics thereof according to the embodiments are listed for showing the characteristics of the inductors made according to the embodiments of the disclosure. However, the following examples are for purposes of describing particular embodiments only, and are not intended to be limiting. The magnetic material compositions of the embodiments are listed in table 1, and the test results of the characteristics are listed in table 2.

The magnetic powders of embodiments 1-7 and comparative embodiment 1 are all iron-silicon mixture powders mainly formed from 95 wt % of iron and 5 wt % of silicon with a D50 diameter of 10-20 μm. The inorganic ceramic powder FRA-119 adopted in embodiments 1-4 is phosphosilicate glass with a composition of Al₂O₃—P₂O₅−R₂O—F₂, wherein R represents impurity trace metal, and the content of P₂O₅ is 10˜20 wt %. The glass transition temperature of the inorganic ceramic powder FRA-119 is 351° C., and the softening temperature of the inorganic ceramic powder FRA-119 is 380° C. The inorganic ceramic powder 4960F(S) adopted in embodiments 5-7 is borosilicate glass with a composition of SiO₂—Al₂O₃—B₂O₃—R₂O—BaO—ZnO, wherein R represents impurity trace metal, and the content of B₂O₃ is 10˜20 wt %. The glass transition temperature of the inorganic ceramic powder 4960F(S) is 464.5° C., and the softening temperature of the inorganic ceramic powder 4960F(S) is 530° C. The contents of the magnetic metal powders in embodiments 1-7 and comparative embodiment 1 are all 100 weight parts.

TABLE 1

| | | | Specific | |
|---|---|---|---|---|
| | Inorganic | D50 particle | surface area | Weight |
| | ceramic powder | diameter | (BET) | part |
| Comparative | N/A | N/A | N/A | 0 |
| embodiment 1 | | | | |
| Embodiment 1 | FRA-119 | 11.99 μm | 1.10 m²/g | 0.05 |
| Embodiment 2 | FRA-119 | | | 0.1 |
| Embodiment 3 | FRA-119 | | | 0.3 |
| Embodiment 4 | FRA-119 | | | 1.0 |
| Embodiment 5 | 4960F(S) | 6.12 μm | 1.47 m²/g | 0.1 |
| Embodiment 6 | 4960F(S) | | | 0.3 |
| Embodiment 7 | 4960F(S) | | | 1.0 |

After the magnetic material powder and the inorganic ceramic powder in each of the magnetic material compositions of the embodiments 1-7 as shown in table 1 are mixed uniformly, the magnetic material composition powder is formed and cut for forming the H-shaped magnetic material body as shown in FIGS. 1-2. For comparative embodiment 1, the magnetic metal powder is formed and cut for forming the H-shaped magnetic material body as shown in FIGS. 1-2. Next, the as-formed material bodies of embodiments 1-7 and comparative embodiment 1 are sintered at 850° C. to obtain the magnetic material bodies 100 of embodiments 1-7 and the magnetic material body of comparative embodiment 1. Next, conducting wires 200 are winding around the magnetic material bodies, and then the electrical characteristics as listed in table 2 are measured. The H-shaped magnetic material bodies of embodiments 1-7 and comparative embodiment 1 have a length of about 2.0±0.2 mm, a width of about 1.6±0.2 mm, and a maximum height of about 1.0 mm. The conducting wires 200 adopted in embodiments 1-7 and comparative embodiment 1 have a line diameter of about 0.06 mm and are winding around the magnetic material body for 26.5 circles.

TABLE 2

| | | | | Inductance (μH) | | |
|---|---|---|---|---|---|---|
| | Size (mm) | | | Average | Maximum | Minimum |
| | Length | Width | Height | (Avg.) | (Max.) | (Min.) |
| Comparative | 2.096 | 1.695 | 0.882 | 7.21 | 7.47 | 6.97 |
| embodiment 1 | | | | | | |
| Embodiment 1 | 2.124 | 1.725 | 0.895 | 6.67 | 6.92 | 6.44 |
| Embodiment 2 | 2.137 | 1.732 | 0.906 | 6.15 | 6.48 | 5.98 |
| Embodiment 3 | 2.151 | 1.746 | 0.912 | 5.91 | 6.17 | 5.55 |
| Embodiment 4 | 2.149 | 1.752 | 0.926 | 5.82 | 6.09 | 5.55 |
| Embodiment 5 | 2.111 | 1.715 | 0.895 | 6.99 | 7.33 | 6.72 |
| Embodiment 6 | 2.117 | 1.716 | 0.881 | 6.77 | 6.96 | 6.52 |
| Embodiment 7 | 2.131 | 1.734 | 0.911 | 6.44 | 6.77 | 6.16 |

| | I-sat (%) | | | Surface resistance (MΩ) | | | Strength (kgf) | | |
|---|---|---|---|---|---|---|---|---|---|
| | Avg. | Max. | Min. | Avg. | Max. | Min. | Avg. | Max. | Min. |
| Comparative | 10.36 | 11.36 | 9.15 | 35.1 | 97.1 | 1.37 | 0.34 | 0.5 | 0.25 |
| embodiment 1 | | | | | | | | | |
| Embodiment 1 | 9.47 | 10.12 | 9.10 | 384 | 785 | 183 | 0.32 | 0.4 | 0.25 |
| Embodiment 2 | 9.05 | 9.76 | 8.33 | 2820 | 4000 | 1490 | 0.36 | 0.5 | 0.2 |
| Embodiment 3 | 8.37 | 9.80 | 6.07 | 787 | 1830 | 45.3 | 0.33 | 0.4 | 0.2 |
| Embodiment 4 | 6.60 | 6.78 | 6.17 | 194 | 749 | 29.9 | 0.37 | 0.5 | 0.2 |
| Embodiment 5 | 9.23 | 10.73 | 8.63 | 80.7 | 239 | 21.2 | 0.33 | 0.50 | 0.20 |
| Embodiment 6 | 9.61 | 10.67 | 9.16 | 365 | 632 | 103 | 0.32 | 0.45 | 0.25 |
| Embodiment 7 | 8.52 | 9.36 | 7.75 | 1090 | 2120 | 264 | 0.39 | 0.55 | 0.25 |

The sizes listed in table 2 are the lengths, widths, and heights of the H-shaped magnetic material bodies of embodiments 1-7 and comparative embodiment 1. The I-sat(%) as shown in table 2 indicates the reduction ratio of the inductance after currents are applied to the inductance before currents are applied. Specifically speaking, the inductance after applying currents is L0, the inductance before applying currents is L2, and I-sat(%) is (L1−L0)/L0. The strength as shown in table 2 indicates the applied pressure at which the magnetic material body breaks when the peripheral portion (from above the annular recess 110c) of the H-shaped magnetic material body is under an applied pressure.

As shown in table 2, the magnetic material bodies of embodiments 1-7 have larger sizes than that of the magnetic material body of comparative embodiment 1, which is caused by the inorganic ceramic surface layer 120 formed from the released inorganic ceramic powder and formed on the surface of the magnetic core 110.

As shown in table 2, compared to comparative embodiment 1, the compositions of the magnetic material bodies of embodiments 1-7 all include 0.05-1 weight part of the inorganic ceramic powder, as such, embodiments 1-7 all have better performance in I-sat (lower reduction ratios of inductance) and higher surface resistance, and therefore can maintain strengths similar to that of the magnetic material body of comparative embodiment 1.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A magnetic material composition used for an inductor, comprising:
100 weight parts of a magnetic metal powder, the magnetic metal power comprising 94.5 wt % or higher of iron; and
0.05-1 weight part of an inorganic ceramic powder, the inorganic ceramic powder comprising aluminum oxide.

2. The magnetic material composition according to claim 1, wherein the magnetic metal powder further comprises 3-5.5 wt % of silicon.

3. The magnetic material composition according to claim 1, wherein the inorganic ceramic powder further comprises 10-20 wt % of boron oxide (B₂O₃).

4. The magnetic material composition according to claim 1, wherein the inorganic ceramic powder further comprises 10-20 wt % of phosphorus oxide (P₂O₅).

5. The magnetic material composition according to claim 1, wherein the inorganic ceramic powder further comprises zinc oxide (ZnₓO).

6. The magnetic material composition according to claim 1, wherein an average particle diameter of the inorganic ceramic power is 2-12 μm.

7. The magnetic material composition according to claim 1, wherein an average particle diameter of the magnetic metal powder is larger than or equal to an average particle diameter of the inorganic ceramic powder.

8. The magnetic material composition according to claim 7, wherein the average particle diameter of the magnetic metal powder is 2-5 times of the average particle diameter of the inorganic ceramic powder.

9. An inductor, comprising:
a magnetic material body, a composition of the magnetic material body comprises:
100 weight parts of a magnetic metal powder, the magnetic metal power comprising 94.5 wt % or higher of iron; and
0.05-1 weight part of an inorganic ceramic powder, the inorganic ceramic powder comprising aluminum oxide;
a conducting wire winding around the magnetic material body; and
an exterior resin part covering the conducting wire.

10. The inductor according to claim 9, wherein the magnetic metal powder further comprises 3-5.5 wt % of silicon.

11. The inductor according to claim 9, wherein the inorganic ceramic powder further comprises 10-20 wt % of boron oxide (B₂O₃).

12. The inductor according to claim 9, wherein the inorganic ceramic powder further comprises 10-20 wt % of phosphorus oxide (P₂O₅).

13. The inductor according to claim 9, wherein an average particle diameter of the inorganic ceramic power is 2-12 μm.

14. The inductor according to claim 9, wherein an average particle diameter of the magnetic metal powder is larger than or equal to an average particle diameter of the inorganic ceramic powder.

15. The inductor according to claim 9, wherein the magnetic material body comprises a magnetic core and an inorganic ceramic surface layer, and the inorganic ceramic surface layer has a ceramic external surface.

16. The inductor according to claim 15, wherein the magnetic core has an annular recess and a central pillar, the conducting wire is disposed in the annular recess and winding around the central pillar, and the inorganic ceramic surface layer covers at least an inner surface of the annular recess and a side surface of the central pillar.

17. The inductor according to claim 15, wherein a thickness of the inorganic ceramic surface layer is 15-60 μm.

18. The inductor according to claim 15, wherein the exterior resin part has a resin surface blocked by the inorganic ceramic surface layer, the ceramic external surface forms an interface between the exterior resin part and the magnetic material body, and the inorganic ceramic surface layer is formed between the exterior resin part and the magnetic core for separating the exterior resin part from contacting the magnetic core.

19. A manufacturing method of an electronic component, comprising:
providing a magnetic material composition, the magnetic material composition comprising:
100 weight parts of a magnetic metal powder, the magnetic metal power comprising 94.5 wt % or higher of iron; and
0.05-1 weight part of an inorganic ceramic powder, the inorganic ceramic powder comprising aluminum oxide;
sintering the magnetic material composition for manufacturing a magnetic material body, the magnetic material body comprising:
a magnetic core mainly made of the magnetic metal powder; and
an inorganic ceramic surface layer mainly made of the inorganic ceramic powder, the inorganic ceramic surface layer having a ceramic external surface;
winding a cladding conducting wire around the magnetic material body; and
coating a resin material on a peripheral of the cladding conducting wire for forming an exterior resin part, wherein the exterior resin part covering the peripheral of the cladding conducting wire and contacting a portion of a surface of the magnetic material body is blocked by the inorganic ceramic surface layer, the ceramic external surface forms an interface between the exterior resin part and the magnetic material body, and the inorganic ceramic surface layer is formed between the exterior resin part and the magnetic core for separating the exterior resin part from contacting the magnetic core.
